(19) United States
(12) Patent Application Publication
(10) Pub. No.: US 2002/0119238 A1
(43) Pub. Date: Aug. 29, 2002

(54) Creamy, milk-free o/w emulsion, process for its preparation and its use

(76) Inventor: Murilo Hadad Pires, Lubeck (DE)

Correspondence Address: NIXON & VANDERHYE P.C., 8th Floor, 1100 North Glebe Road, Arlington, VA, 22201, US

(21) Appl. No.: 10/021,301

(22) Filed: Dec. 19, 2001

(30) Foreign Application Priority Data
Dec. 21, 2000 (DE) 100 64 061.3-41

(51) Int. Cl. A23D 7/00

(52) U.S. Cl. 426/602

(57) ABSTRACT

The present invention relates to a creamy, milk-free oil-in-water emulsion (o/w emulsion) which comprises an aqueous phase (a) which contains water, water-soluble carbohydrate, hydrocolloid and optionally further hydrophilic constituents, and an oil phase (b), which contains edible oil and/or edible fat, emulsifier and optionally further lipophilic constituents. The weight ratio of the aqueous phase to the oil phase (a:b) is in the range of 9:1 to 6:4. The invention furthermore concerns a process for the preparation of the creamy, milk-free o/w emulsion as well as its use as a cream substitute in cake and pastry and dessert products.

The invention relates to a creamy, milk-free oil-in-water emulsion (o/w emulsion) a process for its preparation and its use as cream substitute for the preparation of cake and pastry and dessert products.

Milk and cream are o/w emulsions in which the milk fat is finely dispersed in the excess component water in the form of droplets. Real cream is prepared by skimming of milk and contains at least 10 wt.-% fat according to the Milcherzeugnis-Verordnung (MilchErzV) [milk products Regulation]. Whipped cream is described in the MilchErzV as a standard type of cream with at least 30% fat which is pasteurised, ultra-heat-treated (UHT-heated) or sterilized. Along with the constituents contained in the milk, such as water, fat, lactose, salts, whey proteins and caseins, further additives (e.g. stabilizers) can be used in whipping cream products according to MilchErzV.

In recent years, creamy, whippable o/w emulsions which are prepared on the basis of vegetable oils or fats have become an attractive alternative to conventional whipped cream. These products are also called, among other things, analogue cream, artificial cream, vegetable oil cream, imitation cream or cream substitute. For example they are used in whipped form as topping and filling for cakes and gateaux or as decoration for desserts and ice cream. Demand for these products is increasing for reasons of economics, easier handling and quality control as well as more consistent product properties. Distribution routes can be simplified, mainly in regions (e.g. Asia) in which milk is scarce. Moreover, artificial cream has a reduced cholesterol content compared with natural cream, which accommodates the overall increase in the needs of health-conscious consumers (e.g. vegetarians) for products with improved nutritional physiological properties. Finally, religious consumers (e.g. Jews and Muslims) are exerting increased pressure on the food industry for a milk- and protein-free, creamy, whippable o/w emulsion.

It is known from the state of the art to prepare o/w emulsions as whippable cream substitute using milk components such as skimmed milk or buttermilk powder (EP 0 436994 B1, EP 0 454 195 B1, EP 469656 B1, EP 0 563593 B1). The casein and whey proteins contained in milk protein contribute to emulsion stability, maintenance of the foam structure and improvement in taste. However, the use of milk proteins has the disadvantage that these substances denature in the acid pH range and at increased temperature and are complexed by di- or polyvalent metal ions, which can lead to the precipitation of the proteins.

In DD 232 191 A1 a process is described for the preparation of fat-in-water emulsions with a liquid to spreadable consistency without using milk solids, the resulting products being suitable inter alia as cream substitute. These products contain a broad bean protein isolate or its acetylated form in the presence of a salt with di- or polyvalent metal ions (e.g. CaCl₂ or AlCl₃). However the emulsion stability when using vegetable proteins in turn depends in a complex way on the pH value and the level of multivalent metal ions. This requires a very precise concentration setting, in order on the one hand to achieve an adequate emulsion viscosity (by bridging of protein chains with metal ions) and on the other hand to prevent a precipitation of the protein. A further disadvantage is that the taste of a cream substitute in which vegetable proteins and/or di- or polyvalent metal salts are processed is often not accepted by consumers (e.g. coffee whitener). Whippable non-dairy creams are described in EP 0 509 579 B1 and EP 0 691 080 A2, in which the use of proteins is not absolutely necessary in order to achieve an acceptable whippability. However the emulsion has to contain 0.005 to 3.0 wt.-% (EP 0 509 579 B1) or 0.1 to 3.0 wt.-% (EP 0 691 080 A2) of a di-, tri- or tetravalent metal salt or alkaline earth metal salt suitable for nutrition purposes. Along with the taste problems already mentioned, it is known that di- and polyvalent metal ions can also crosslink ionic thickeners (e.g. xanthane) due to the complexing of carboxylate groups. This can lead to a marked increase in emulsion viscosity, in extreme cases to formation of lumps and thus to a decreased sensory quality of the finished product.

EP 0 455 288 B1, EP 0 483 896 B1, EP 0 540 086 A1 and EP 0 558 113 B1 disclose whippable non-dairy creams in which proteins are likewise optional components. These have however the disadvantage that no water-soluble carbohydrates (e.g. saccharose) are included in them. High sugar concentrations are however often desired if the whipped cream substitute is to be used as filling or topping for cake and pastry and dessert products.

The object of the invention is therefore to provide a o/w emulsion as cream substitute which does not have the disadvantages described above of the products known from the state of the art. In particular the o/w emulsion is intended to

contain no milk constituents, in order that it can be called “vegetable fat cream free from milk constituents”;

have a liquid, creamy consistency and high emulsion stability without using animal or vegetable proteins as well as salts of di- or polyvalent metal ions;

be whippable with domestic mixers, domestic whisks and industrial whisks with an acceptable accompanying increase in volume;

be stable in the acid pH range and remain whippable; and

remain mechanically stable in whipped form, have an improved microbiological and freezing resistance as well as a taste accepted by consumers, in order to be able to use them in particular in cake and pastry and desserts products.

In order to achieve this object, a creamy, milk-free o/w emulsion is proposed which is characterized in that it contains (a) an aqueous phase, which contains water, water-soluble carbohydrate, hydrocolloid and optionally further hydrophilic constituents, and (b) an oil phase, which comprises edible oil and/or edible fat, emulsifiers and optionally further lipophilic constituents, the weight ratio of the aqueous phase to oil phase (a:b) being in the range from 9:1 to 6:4.

According to the invention the o/w emulsion can also simply consist of the aqueous phase (a) and the oil phase (b).

A subject of the invention is also a process for the preparation of the creamy, milk-free o/w emulsion according to the invention, which is characterized in that

a) edible oil and/or edible fat is heated to a temperature above its melting point and the lipophilic constituents are mixed with the heated edible oil and/or edible fat,

b) water is heated separately and the hydrophilic constituents are mixed with the heated water,

c) the oil phase is dispersed into the water phase,

d) the obtained pre-emulsion is heat-treated (pasteurized, ultra-heat-treated or sterilized),

e) the pre-emulsion is cooled to a temperature below 100° C,

f) the pre-emulsion is homogenized under a pressure of 50 to 250 bar and

g) the obtained oil-in-water emulsion is cooled and packed.

A subject of the invention is furthermore the use of the creamy, milk-free o/w emulsion according to the invention as cream substitute for the preparation of cake and pastry and dessert products.

The proportions given below in weight percent of the individual components in the o/w emulsions refer, unless stated otherwise, to the total emulsion.

According to the invention the creamy, milk-free o/w emulsion comprises water-soluble carbohydrate, in particular monosaccharides, oligosaccharides, polysaccharides or mixtures of two or more of the same. By water-soluble carbohydrate is also meant products which come about from the hydrolytic or enzymatic degradation of polysaccharides (e.g. starch, inulin) and are accordingly mixtures of mono-, oligo-, and polysaccharides (e.g. glucose-syrup). Preferred water-soluble carbohydrates are glucose, fructose, saccharose, glucose-syrup, dried glucose-syrup, fructose-syrup, maltodextrins, oligofructoses or mixtures of two or more of the same. A mixture is particularly preferred which contains saccharose, glucose-syrup (with a dextrose-equivalent, DE, of 40) and dried glucose-syrup (with a DE of 20) in a weight ratio of 1:0.9 to 1.1:0.6 to 0.8. The proportion of water-soluble carbohydrate in the o/w emulsion is 10 to 50 wt.-%, preferably 20 to 40 wt.-% and in particular 25 to 35 wt.-%.

Natural and/or modified polysaccharides are used as hydrocolloid. Guar, locust bean gum, xanthane, pectin, carrageenan, alginates, carboxymethylcellulose, hydroxypropylmethylcellulose, microcrystalline cellulose, inulin or mixtures of two or more of the same are preferred. In a particularly preferred embodiment the o/w emulsion according to the invention comprises a hydrocolloid-stabilizing system which contains hydroxypropylmethylcellulose, microcrystalline cellulose and guar in a weight ratio of 1:0.5 to 0.75:0.1 to 0.3. The hydrocolloid content of the o/w emulsion is 0.1 to 3 wt.-%, preferably 0.1 to 1.0 wt.-% and in particular 0.4 to 0.8 wt.-%.

The o/w emulsion according to the invention can optionally contain acidulant as further hydrophilic constituent. Lactic acid, citric acid, tartaric acid, malic acid or mixtures of two or more of the same for example can be used as acidulant. The proportion of acidulant in the o/w emulsion according to the invention is 0.001 to 0.1 wt.-%, preferably 0.005 to 0.08 wt.-% and in particular 0.01 to 0.05 wt.-%.

The edible oils and/or edible fats customary for nutrition purposes are used as edible oil and/or edible fat. Palm oil, palm-kernel oil, sunflower oil, soya oil, rape-seed oil, coconut oil, technologically modified derivatives of the above-mentioned oils and fats or mixtures of two or more of the same are preferably used. Technologically modified derivatives are those which are obtained from edible oil and/or edible fat by various processes (e.g. hardening). The proportion of edible oil and/or edible fat in the o/w emulsion is 10 to 40 wt.-%, preferably 20 to 30 wt.-%.

The o/w emulsion according to the invention furthermore comprises emulsifiers. Suitable emulsifiers are known to the person skilled in the art and are chosen from the group of the emulsifiers approved for foods. Preferred emulsifiers are mono- and diglycerides of edible fatty acids (MDG), polysorbates (e.g. Polysorbat 60, i.e. polyoxyethylene-60-sorbitanmonostearate), sorbitan esters of edible fatty acids (Span), sodium stearoyl lactylate (NSL), mono- and diglycerides of edible fatty acids esterified with lactic acid (LACTEM), acetic acid (ACETEM) or diacetyltartaric acid (DATEM), polyglycerine esters of edible fatty acids (PGE), lecithins or mixtures of two or more of the same. An emulsifier system is particularly preferred which contains non-ionic emulsifier, preferably mono- and diglycerides of edible fatty acids, mono- and diglycerides of edible fatty acids esterified with lactic acid (LACTEM), acetic acid (ACETEM) or diacetyltartaric acid (DATEM) and/or polyoxyethylene-60-sorbitanmonostearate (Polysorbat 60), and anionic emulsifier, preferably sodium stearoyl lactylates. Most preferred is an emulsifier system which contains sodium stearoyl lactylates, polyoxyethylene-60-sorbitanmonostearate and mono- and diglycerides of the edible fatty acids in a weight ratio of 1:0.5 to 0.7:0.3 to 0.5. The emulsifier content of the o/w emulsion is 0.1 to 5 wt.-%, preferably 0.2 to 3 wt.-% and in particular 0.4 to 2.0 wt.-%.

Furthermore, sugar substitutes, sweeteners, salts of alkali metals, flavors, dyes, dye pigments, vitamins and gases for example can be processed as customary additives in the o/w emulsion according to the invention.

For the preparation of the creamy, milk-free o/w emulsion

a) edible oil and/or edible fat is heated to a temperature above its melting point and the lipophilic constituents are mixed with the heated edible oil and/or edible fat,

b) water is heated separately and the hydrophilic constituents are mixed with the heated water,

c) the oil phase is dispersed into the water phase,

d) the obtained pre-emulsion is heat-treated (pasteurized, ultra-heat-treated or sterilized),

e) the pre-emulsion is cooled to a temperature below 100° C.,

f) the pre-emulsion is homogenized under a pressure of 50 to 250 bar and

g) the obtained oil-in-water emulsion is cooled and packed.

In stage (a) the edible oil and/or edible fat is preferably heated to a temperature in the range of 50° C. to 80° C. and in particular to 650 to 75° C.

In stage (b) the water is preferably heated to 60° C. to 90° C. and in particular to 70° C. to 75° C.

The pre-emulsion obtained from stages (a) to (c) is preferably pasteurised or ultra-heat-treated in a plate heat exchanger. The pasteurising is preferably carried out at a temperature of 68° C. to 110° C. for 10 seconds to 30 minutes. The ultra-heat treatment preferably takes place at 138° C. to 142° C. for 1 to 30 seconds, preferably for 2 to 10 seconds.

In stage (e) the pre-emulsion in the plate heat exchanger is preferably cooled to 65° C. to 75° C.

The homogenization of the pre-emulsion in stage (f) is preferably carried out at a pressure of 100 to 180 bar in a high-pressure homogenizer.

The o/w emulsion obtained from stages (a) to (f) is cooled in stage (g) in a suitable way to 3° C. to 35° C., preferably to 5° C. to 15° C., and e.g. packed under aseptic conditions.

The creamy, milk-free o/w emulsion is preferably white, has a pleasant taste and has a liquid-to-creamy consistency. The viscosity of the o/w emulsion according to the invention at 10° C. is generally 50 to 500 mPa-s, preferably 100 to 300 mPa·s (measured by Rotovisko RV 12, measuring head NV ST, measuring system 500, at 32 min⁻¹). It can be packed as a conventional cream (e.g. in customary plastic tubs).

Surprisingly, it was shown that the o/w emulsion according to the invention is storage-stable in a pH range of 2.5 to 7.5 and whippable. This has the advantage that e.g. acidulant can already be incorporated into the emulsion during the preparation and thus sterile acid o/w emulsions can be obtained. “Storage-stable” means that the liquid emulsion can be stored for at least 60 to 90 days at a temperature of 1° C. to 15° C. without relevant chemical or physical changes occurring (e.g. collapse of the emulsion) which can lead to an impairment of the product quality. “Whippable” means that the liquid emulsion can be whipped with electric domestic mixers or whisks customary in the trade (e.g. Hobart or Kitchenaid) as well as with industrial whisks with an accompanying increase in volume of at least 200% and in particular of 250 to 300%. For example, whipping times between 2 and 4 mins are necessary for this when using a domestic whisk of the Hobart type at maximum speed. The presence of acidulant does not lead to a reduction in whippability.

Alternatively, the o/w emulsion according to the invention can, after its preparation according to process steps (a) to (g), be mixed in a further step (h) with acidulant, food product selected from acid, neutral and/or alcohol-containing food product or mixtures of two or more of the same. O/w emulsions according to the invention which are mixed with acidulant, food product selected from acid, neutral and/or alcoholic food product or mixtures of two or more of the same are likewise characterized by storage-stability and whippability. The acidulants mentioned above can be considered. The proportion of acidulant relative to the mixed o/w emulsion is 0.02 to 0.5 wt.-%, preferably 0.04 to 0.3 wt.-% and in particular 0.07 to 0.2 wt.-%. Acid food products are for example fruits, fruit preparations, fruit syrups, fruit juices, sour milk products, yoghurt products or mixtures of two or more of the same. Neutral food products are e.g. chocolate and vanilla preparations or mixtures of the same. Alcohol-containing food products are for example liqueurs (e.g. advocaat, cream liqueur). The weight ratio of emulsion to acid, neutral and/or alcohol-containing food product is preferably between 99:1 and 60:40 and in particular between 90:10 and 70:30. Most preferred is a mixture which contains the o/w emulsion according to the invention, fruit syrup and citric acid in a weight ratio of 1:0.1 to 0.3:0.0005 to 0.003.

The o/w emulsion according to the invention, mixtures of the same with acidulant, food product selected from acid, neutral and/or alcohol-containing food product or mixtures of two or more of the same as well as their whipped products also display a good freezing resistance, i.e. they withstand the freezing and defrosting process, without the emulsion collapsing or a change in the foam properties being observed. This enables the whipped and frozen product to be defrosted again when needed and then ready to use straightaway (e.g. able to be piped), productivity and operational efficiency in the pastries and dessert sector thereby being improved.

The o/w emulsion according to the invention is suitable as a substitute product for conventional creams and is used in particular in the cake and pastry and dessert sector, e.g. as topping, filling or decoration for cakes, gateaux, desserts, ice cream, frozen gateaux and frozen desserts.

The invention is explained in more detail with the help of the following examples. Unless stated otherwise, all percentages are by weight which always, as in the above description, relate to the weight composition.

### EXAMPLES

### Example 1

A creamy, milk-free o/w emulsion was prepared which had the following recipe:

| Components | (wt.-%) |
|---|---|
| Emulsifiers | |
| Mono- and diglycerides of edible fatty acids | 0.20 |
| Sodium stearoyl lactylates | 0.50 |
| Polysorbat 60 | 0.30 |
| Hydrocolloids | |
| Guar | 0.05 |
| Microcrystalline cellulose | 0.16 |
| Hydroxypropylmethylcellulose | 0.24 |
| Water-soluble carbohydrates | |
| Dried glucose syrup 20 DE | 7.00 |
| Glucose syrup 40 DE | 10.00 |
| Saccharose | 10.00 |
| Hardened palm-kernel oil | 18.00 |
| Hardened coconut oil | 12.00 |
| water | 41.35 |
| Dyes and flavors | 0.20 |

For the preparation of the o/w emulsion according to the invention with the above recipe, the hardened palm-kernel oil and the hardened coconut oil was heated to 70° C. and mixed with the emulsifiers and further lipophilic constituents. Water was separately heated to 75° C. and mixed with the water-soluble carbohydrates, the hydrocolloid and further hydrophilic constituents. The oil phase was then mixed with the water phase. The pre-emulsion obtained was UHT-treated in a plate heat exchanger at 142° C., cooled to 75° C. in the same plate heat exchanger, homogenized at 170 bar in a high-pressure homogenizer, cooled to 15° C. in the plate heat exchanger and then packed.

The thus-prepared o/w emulsion had a pleasant taste, a good pourability and a high stability. It was whippable in a domestic whisk of the Hobart type (at maximum speed). The resulting product was stable and displayed a solid and creamy consistency. The increase in volume vis-à-vis the liquid emulsion was greater than 250%. The whipping time was approx. 3 min.

### Example 2

The o/w emulsion from example 1 was mixed with fruit syrup and citric acid according to the following recipe before whipping:

| Components | (wt.-%) |
|---|---|
| O/w emulsion (example 1) | 79.90 |
| Fruit syrup | 20.00 |
| 50% citric acid solution | 0.10 |

The pH value of the mixed o/w emulsion was between 2.5 and 3. It was whipped in a domestic whisk of the Hobart type (at maximum speed). The whipped product was stable and displayed a creamy consistency. The product is suitable as filling for cakes or for the decoration of desserts, gateaux etc. The increase in volume was greater than 200%. The whipping time was approx. 2 min.

### Example 3

An o/w emulsion according to the invention was prepared which contained citric acid-anhydride as acidulant, and had the following recipe:

| Components | (wt.-%) |
|---|---|
| Emulsifiers | |
| Mono- and diglycerides of edible fatty acids | 0.40 |
| Sodium stearoyl lactylate | 0.30 |
| LACTEM | 0.20 |
| Hydrocolloids | |
| Microcrystalline cellulose | 0.18 |
| Hydroxypropylmethylcellulose | 0.18 |
| Locust bean gum | 0.10 |
| Water-soluble carbohydrates | |
| Saccharose | 12.00 |
| Dried glucose syrup 20 DE | 6.00 |
| Hardened palm-kernel oil | 28.00 |
| Citric acid (anhydrous) | 0.02 |
| Water | 52.42 |
| Dyes and Flavors | 0.2 |

For the preparation of the o/w emulsion according to the invention with the above recipe, the hardened palm-kernel oil was heated to 70° C. and mixed with the emulsifiers and further lipophilic constituents. Water was separately heated to 75° C. and mixed with the water-soluble carbohydrates, the hydrocolloids and further hydrophilic constituents. This mixture had a pH value of 4.5. The oil phase was then mixed with the water phase. The pre-emulsion obtained was UHT-treated in a plate heat exchanger at 142° C., cooled to 75° C. in the same plate heat exchanger, homogenized at 170 bar in a high-pressure homogenizer, cooled to 15° C. in the plate heat exchanger and then packed.

The thus-prepared o/w emulsion had a pleasant taste, a good pourability and a high stability. It was whippable in a domestic whisk of the Hobart type (at maximum speed). The resulting product was stable and displayed a creamy consistency. The increase in volume vis-à-vis the liquid emulsion was greater than 250%. The whipping time was approx. 3 min. The pH value (after 2½ months' storage) was 4.2.

1. Creamy, milk-free o/w emulsion, comprising
a) an aqueous phase which contains water, water-soluble carbohydrate, hydrocolloid and optionally further hydrophilic constituents, and
b) an oil phase which contains edible oil and/or edible fat, emulsifier and optionally further lipophilic constituents,
the weight ratio of the aqueous phase to the oil phase (a:b) being in the range of 9:1 to 6:4.

2. O/w emulsion according to claim 1, wherein the proportion of water-soluble carbohydrate is 10 to 50 wt.-% (relative to the whole emulsion).

3. O/w emulsion according to one of claims 1 and 2, wherein the water-soluble carbohydrate is selected from glucose, fructose, saccharose, glucose syrup, dried glucose syrup, fructose syrup, maltodextrins and/or oligofructoses.

4. O/w emulsion according to one of the previous claims, wherein the proportion of hydrocolloid is 0.1 to 3 wt.-% (relative to the whole emulsion).

5. O/w emulsion according to one of the previous claims, wherein the hydrocolloid is selected from guar, locust bean gum, xanthane, pectin, carrageenan, alginates, carboxymethylcellulose, hydroxypropylmethylcellulose, microcrystalline cellulose and/or inulin.

6. O/w emulsion according to one of the previous claims, containing a hydrocolloid-stabilizing system comprising hydroxypropylmethylcellulose, microcrystalline cellulose and guar in a weight ratio of 1:0.5 to 0.75:0.1 to 0.3.

7. O/w emulsion according to one of the previous claims, optionally containing acidulant as further hydrophilic constituent.

8. O/w emulsion according to one of the previous claims, wherein the acidulant is selected from lactic acid, citric acid, tartaric acid and/or malic acid and the proportion of acidulant is 0.001 to 0.1 wt.-% (relative to the whole emulsion).

9. O/w emulsion according to one of the previous claims, wherein the proportion of edible oil and/or edible fat is 10 to 40 wt.-% (relative to the whole emulsion).

10. O/w emulsion according to one of the previous claims, wherein the edible oil and/or edible fat is selected from palm oil, palm-kernel oil, sunflower oil, soya oil, rape-seed oil, coconut oil and/or technologically modified derivatives of the same.

11. O/w emulsion according to one of the previous claims, wherein the proportion of emulsifier is 0.1 to 5 wt.-% (relative to the whole emulsion).

12. O/w emulsion according to one of the previous claims, wherein the emulsifier is selected from mono- and diglycerides of the edible fatty acids, polysorbates, sorbitan esters of edible fatty acids, sodium stearoyl lactylates, mono- and diglycerides of edible fatty acids esterified with lactic acid (LACTEM), acetic acid (ACETEM) or diacetyltartartic acid (DATEM), polyglycerine esters of edible fatty acids and/or lecithins.

13. O/w emulsion according to one of the previous claims, containing an emulsifier system comprising sodium stearoyl lactylates, polyoxyethylene 60 sorbitanmonostearate and mono- and diglycerides of the edible fatty acids in a weight ratio of 1 to 0.5 to 0.7 0.3 to 0.5.

14. O/w emulsion according to one of the previous claims, being storage-stable in a pH range of 2.5 to 7.5 and being whippable with an accompanying increase in volume of at least 200%.

15. O/w emulsion according to one of the previous claims, being mixed as an already-developed emulsion with acidulant, food product selected from acid, neutral and/or alcohol-containing food product or mixtures of two or more of the same.

16. O/w emulsion according to claim 15, wherein the acidulant is selected from lactic acid, citric acid, tartaric acid and/or malic acid and the proportion of acidulant is 0.02 to 0.5 wt.-% (relative to the mixed emulsion).

17. O/w emulsion according to claim 15 or 16, wherein the acid, neutral and/or alcohol-containing food product is selected from fruits, fruit preparations, fruit syrups, fruit juices, sour milk products, yoghurt products, chocolate preparations, vanilla preparations and/or liqueurs and the weight ratio of emulsion to acid, neutral and/or alcoholic food product is between 99:1 and 60:40.

18. Process for the preparation of a creamy, milk-free o/w emulsion as defined in one of claims 1 to 14, wherein
a) edible oil and/or edible fat is heated to a temperature above its melting point and the lipophilic constituents are mixed with the heated edible oil and/or edible fat,
b) water is heated separately and the hydrophilic constituents are mixed with the heated water,
c) the oil phase is dispersed into the water phase,
d) the obtained pre-emulsion is heat-treated (pasteurized, ultra-heat-treated or sterilized),
e) the pre-emulsion is cooled to a temperature below 100° C.,
f) the pre-emulsion is homogenized under a pressure of 50 to 250 bar and
g) the obtained oil-in-water emulsion is cooled and packed.

19. Process according to claim 18 for the preparation of a creamy, milk-free o/w emulsion as defined in one of claims 15 to 17, wherein the emulsion from stage g) is mixed in a further step h) with acidulant, food product selected from acid, neutral and/or alcohol-containing food products or mixtures of two or more of the same.

20. Use of the creamy, milk-free o/w emulsion as defined in one of claims 1 to 17 or prepared as defined in claim 18 or 19 as cream substitute for the preparation of cake and pastry and dessert products.
